(19) United States
(12) Patent Application Publication
(10) Pub. No.: US 2023/0210051 A1
(43) Pub. Date: Jul. 6, 2023

(54) BATTERY MANAGEMENT SYSTEM AND METHOD FOR ELECTRIC MOWER

(71) Applicant: Honda Motor Co., Ltd., Tokyo (JP)

(72) Inventors: Kyusang RO, Chapel Hill, NC (US); Brian Christopher BENDER, Mebane, NC (US)

(21) Appl. No.: 17/569,997

(22) Filed: Jan. 6, 2022

(51) Int. Cl. A01D 34/68; H02J 7/00; B60L 58/10; A01D 34/82; A01D 34/78

(52) U.S. Cl. CPC A01D 34/6818; H02J 7/0048; H02J 7/007188; H02J 7/0063; B60L 58/10; A01D 34/824; A01D 34/78; B60L 2200/40; A01D 2101/00

(57) ABSTRACT

A battery management system for a lawnmower that can include a first switch configured to issue a wake-up signal in response to a wake-up input, issue a battery status request signal in response to a battery status input, and issue a shut-down signal in response to a shut-down input. A first controller can be configured to, switch the second switch to an ON state to electrically connect the battery to the electrically powered device when the first controller receives the wake-up signal, cause the display to display information indicative of a status of the battery when the first controller receives the battery status request signal, and switch the second switch to an OFF state to terminate output from the battery to the electrically powered device when the first controller receives the shut-down signal.

### BACKGROUND

The disclosed subject matter relates to a control system for managing battery operation in an electric mower. More particularly, the disclosed subject matter relates to an apparatus that incorporates a control-by-wire-operation of an electric mower.

Electric mowers can include an implement driving assembly that drives at least one implement and a propulsion drive assembly that propels the machine along a travel surface. The implement driving assembly and the propulsion drive assembly can be coupled to a power source such as but not limited to an internal combustion engine or an electric motor. Electrical components of the mower, such as the power source, can draw electrical current from an internal power supply of the mower. The mower can be configured as a walk-behind machine or possibly can be a ride on machine such as a tractor, zero turn radius ZTR machine, ride behind machine, or other machine.

The implement drive assembly can include one or more user inputs that control the movement of the implement. For example, the implement drive assembly can include a user input that stops movement of the implement when the operator of the machine releases the user input.

Once the movement of the implement has been stopped, the electrical components of the machine can continue to draw power from the internal power supply until the power supply is removed or shut down.

### SUMMARY

Some embodiments are directed to a battery management system for a lawnmower having a handle, a display mounted on the handle, a battery, and an electrically powered device, the battery management system can include a first switch configured to issue a wake-up signal in response to a wake-up input, issue a battery status request signal in response to a battery status input, and issue a shut-down signal in response to a shut-down input; a second switch between the battery and the electrically powered device; and a first controller that can be configured to, switch the second switch to an ON state to electrically connect the battery to the electrically powered device when the first controller receives the wake-up signal, cause the display to display information indicative of a status of the battery when the first controller receives the battery status request signal, and switch the second switch to an OFF state to terminate output from the battery to the electrically powered device when the first controller receives the shut-down signal.

Some embodiments are directed to a battery management system for a lawnmower having a handle, a display mounted on the handle, a battery, and an electrically powered device, the battery management system can include a switch mounted on the handle; and a power controller that can be configured to, switch a power switch to an ON state to electrically connect the battery to the electrically powered device when the power switch is in an OFF state and the power controller receives a first signal from the switch, cause the display to display information indicative of a status of the battery when the power controller receives the first signal and the power switch is the ON state, switch the power switch to the OFF state to terminate output from the battery to the electrically powered device when the power switch is in the ON state and the power controller receives a second signal from the switch that is different from the first signal.

Some embodiments are directed to a battery management system for a lawnmower having a deck, a handle extending from the deck, a display mounted on the handle, a battery, a blade rotatably supported in the deck, and a blade motor, the battery management system can include a battery switch mounted on the handle; a motor controller connected to the blade motor; a power switch between the battery and the motor controller. A power controller can be configured to, switch the power switch to an ON state to electrically connect the battery to the motor controller when the power switch is in an OFF state and the power controller receives a first signal from the battery switch, cause the display to display information indicative of a status of the battery when the power controller receives the first signal and the power switch is the ON state, switch the power switch to the OFF state to terminate output from the battery to the motor controller when the power switch is in the ON state and the power controller receives a second signal from the battery switch that is different from the first signal.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a lawnmower made in accordance with principles of the disclosed subject matter.

FIG. 2 is perspective schematic view of a power source assembly and a control system for operating a cutting blade and propelling the lawnmower of FIG. 1, with exterior portions of the lawnmower shown in phantom.

FIG. 3 is a schematic representation of the handle control unit of the lawnmower of FIG. 1.

FIG. 4 is a schematic illustration of a control system for the lawnmower of FIG. 1.

FIG. 5 is a flowchart illustrating exemplary operational steps of a first function of the control system for the lawnmower of FIG. 1.

FIG. 6 is flowchart illustrating exemplary operational steps of a second function and a third function of the control system for the lawnmower of FIG. 1.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

An electric lawnmower can include an internal power supply such as a battery pack that includes one or more battery cells. The battery pack can be attached or mounted to the mower during operation.

In order to operate the mower, the battery pack can be turned on so as to provide electrical power to a plurality of electronic components of the mower. However, an operator may desire to disconnect or turn off the battery depending on certain operational conditions. For example, if an operator of the mower detects an undesirable amount of moisture contacting the mower, the operator may wish to disconnect the electrical power of battery.

Additionally, if an operator determines that the electrical current of the mower should be immediately ceased, the operator may wish to stop the battery from powering the electronic components of the lawnmower without having to reach down near the battery.

Finally, an operator may want to know the health status of the battery while operating the lawnmower. The operator may also desire to know the health status of the battery without reaching down or positioning himself near the battery to view a health status indicator.

Thus, there is a need for a battery management system for a mower that can facilitate control of the battery from an accessible location such as a handle, the system functions including turning on the battery, checking a battery health status, and turning off the battery.

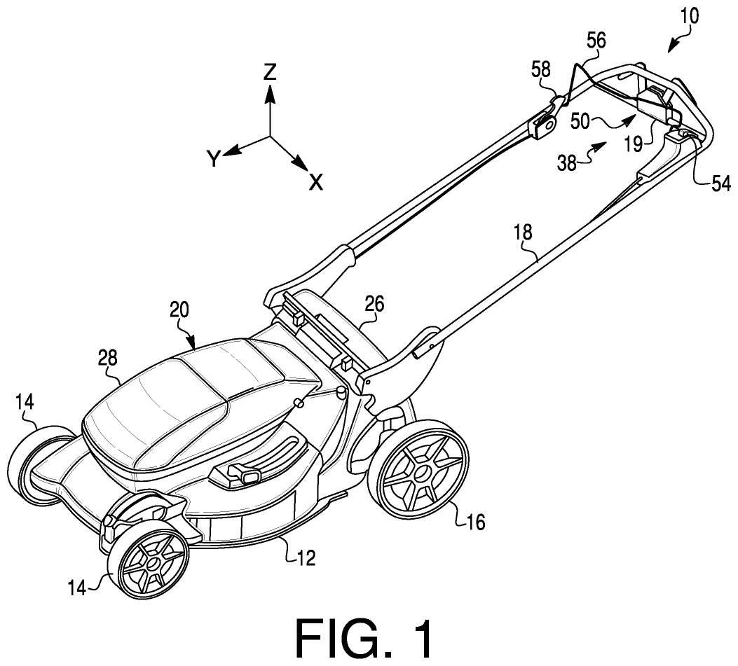

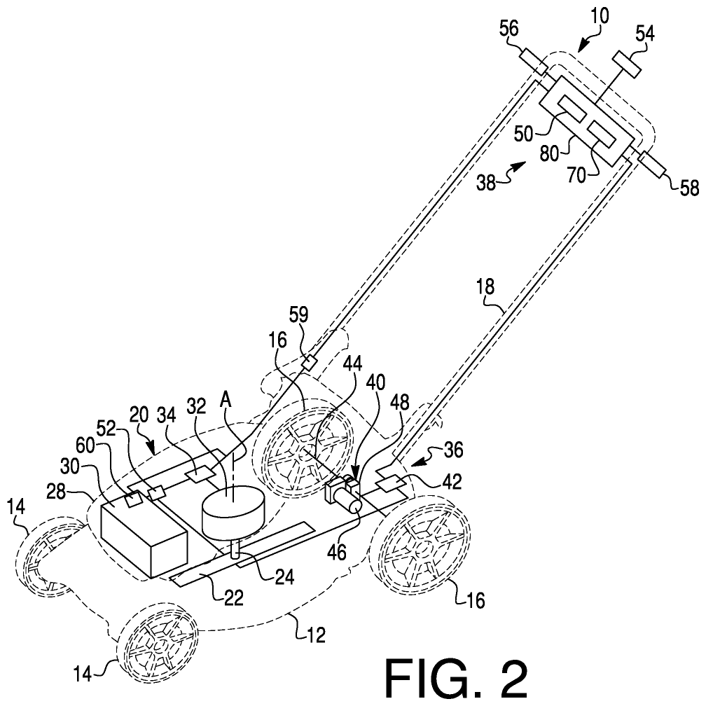

FIG. 1 illustrates an embodiment of a lawnmower 10 configured as a walk-behind self-propelled machine. The lawnmower 10 can include a cutter housing 12, a pair of front wheels 14, a pair of rear wheels 16, a handle 18, a display 19, a power source assembly 20, and a control system 38. The rear wheel 16 on the right side of the lawnmower is obstructed from view in FIG. 1 by the cutter housing 12. FIG. 2 shows the right rear wheel 16 in phantom.

The control system 38 can also be referred to as a battery management system for the electric lawnmower 10 and can include a battery switch 50 (or actuator) configured with three separate functions including: (1) machine “wake up” on initial actuation such that a battery pack 30 delivers power to a motor controller 70; (2) control of a battery status indicator (for example, at the display 19) while the lawnmower 10 is operating; and (3) turning off the battery pack 30 after the lawnmower 10 operation has been stopped (e.g., through switch 50 being held for a predetermined time or repeated actuation of the switch 50).

Referring to FIG. 2, the lawnmower 10 can include a blade 22 and a blade shaft 24 connected to each of the blade 22 and the power source assembly 20. The power source assembly 20 can be configured to selectively rotate the blade shaft 24 and the blade 22 in the cutter housing 12 about a blade axis A. The blade shaft 24 can be referred to as a component of the power source assembly 20. Alternatively, the blade shaft 24 can be referred to as a component that is connected to and driven by the power source assembly 20.

The cutter housing 12 can be referred to as a mower deck or as a cutter deck or as a deck. Referring to FIG. 1, the cutter housing 12 can include an opening at a rear end 26 of the cutter housing 12. The lawnmower 10 can include a collection bag that can be selectively attached to and detached from the rear end 26. The opening and the collection bag are omitted for simplicity and clarity of the drawing figures. The collection bag can be in communication with the opening such that vegetation clippings produced by the blade 22 can be collected in the collection bag.

FIG. 2 schematically illustrates exemplary components of the power source assembly 20. The power source assembly 20 can include a housing 28 (shown in phantom), the battery pack 30, a blade motor 32, a blade motor driver 34, a drive assembly 36, and the control system 38. Referring to FIGS. 1 and 2, the housing 28 can contain the battery pack 30, the blade motor 32 and the blade motor driver 34. The drive assembly 36 can be spaced away from the housing 28.

The housing 28 can include a hinged lid or removable lid to provide access to the battery 30. The battery 30 can be removable from the housing 28 or fixed therein.

The battery pack 30 (also referred to as the battery) can include at least one battery cell and a case that houses the at least one battery cell. The battery cell can be configured to store electricity and supply electricity to any one of, or combination of, a plurality of electrically powered devices in the lawnmower 10.

The plurality of electrically powered devices can include, but is not limited to, the main controller 70, the blade motor 32, the drive transmission 40, the propulsion motor driver 42, the handle controller 80, a handle switch 54, a blade switch 56, a power switch 52, the battery switch 50, and the display 19.

The control system 38 can include a plurality of user inputs (sensors/switches) including the battery switch 50, the transmission speed switch 58, the handle switch 54, and the blade switch 56. The control system 38 can include the power controller 60, the main controller 70 and the power switch 52. The control system 38 can be mounted on the handle 18 in any appropriate position and orientation on the handle 18 that can facilitate actuation of the user inputs by an operator of the lawnmower 10. The control system 38 can be configured to actuate one or more operational features of the lawnmower 10. In addition, the control system 38 can be a control-by-wire system.

The battery switch 50 (also referred to as the battery status switch or the first switch) can be mounted on the handle 18. The battery switch 50 can be in electrical communication with each of the power controller 60, the power switch 52, and the main controller 70. Operation of the battery switch 50 will be discussed in detail below.

The handle switch 54 (also referred to as the third switch) can be mounted on the handle 18 and in electrical communication with the handle controller 80 and the motor controller 70. Operation of the handle switch 54 will be discussed in detail below.

The blade switch 56 (also referred to as the blade handle switch or the fourth switch) can be rotatably mounted on the handle 18 and in electrical communication with the handle controller 80 and the motor controller 70. Operation of the blade switch 56 will be discussed in detail below.

The main controller 70 can also be referred to as the motor controller or the second controller. The main controller 70 can be in electrical communication with the battery pack 30, the propulsion motor driver 42, and each of user inputs 58, 56, 54, and 50. The main controller 70 can be configured to signal the blade motor driver 34 to initiate, adjust or terminate supply of voltage or current from the battery pack 30 to the blade motor 32 based on inputs received from any of the battery pack 30, the blade motor 32 and the user inputs 58, 56, 54. The main controller 70 can be configured to signal the propulsion motor driver 42 to initiate, adjust or terminate supply of voltage or current from the battery pack 30 to the propulsion motor 46 based on inputs received from any of the battery pack 30, the propulsion motor 46, and the inputs 58, 56, 54, and 50. The main controller 70 can be mounted at any appropriate location on the lawnmower 10 such as but not limited to an upper end of the handle 18 that can be manipulated by the operator to steer the lawnmower 10. Operation of the main controller 70 will be discussed in detail below.

The power controller 60 can also be referred to as the first controller or the power control unit (PCU). The power controller 60 can be in electrical communication with the battery 30, the battery switch 50, the power switch 52, and the main controller 70. The power controller 60 can be configured to turn on or off power in response to actuation of the battery switch 50. The power controller 60 can electrically connect or terminate power by changing the power switch 52 between the ON state and the OFF state by switching one or more power transistors to adjust the supply of electrical power. The power controller 60 can have an independent electrical connection to the battery switch 50 separate from the other electrical connections of the power controller 60 to the main controller 70. The power controller 60 can be mounted on the battery 30 and part of the battery assembly. Alternatively, the power controller 60 can be separate from the battery 30 and located in any other appropriate location in the lawnmower 10. Operation of the power controller 60 will be discussed in detail below.

The power switch 52 can be electrically connected to the battery 30 and the power controller 60. The power switch 52 can electrically connect the battery 30 to the plurality of electrically powered devices either alone or in combination. The power switch 52 can be on the battery 30. Alternatively, the power switch 52 can be between the battery 30 and the main controller 70. The power switch 52 can have an ON state and an OFF state. Operation of the power switch 52 will be discussed in more detail below.

The blade motor 32 can be a direct current electric motor or an alternating current electric motor. Embodiments can include a blade motor 32 that is configured as a direct current outer rotor motor that includes an inner stator and an outer rotor. The blade motor 32 can include one or more sensors that provide the blade motor driver 34 with information regarding the temperature, rotational speed, power output, etc., of the blade motor 32. The outer rotor of the blade motor 32 can be directly connected to the shaft 24 in any appropriate manner such that the blade motor 32 can cause the blade shaft 24 to rotate.

The blade motor driver 34 can be in electrical communication with each of the battery pack 30, the blade motor 32, the main controller 70, and the power switch 52. The blade motor driver 34 can be configured to convert power from the battery pack 30 into output power supplied to the blade motor 32. The blade motor driver 34 can be configured to monitor the operational conditions of the blade motor 32 and the battery pack 30. The blade motor driver 34 can be configured to control the voltage and/or current output by the battery pack 30 based on the operational conditions of the blade motor 32 and the battery pack 30 switching one or more power transistors to adjust the supply of electrical power to the blade motor 32.

The blade motor driver 34 can also be configured to control the voltage or current output by the battery pack 30, and to supply the voltage or current to the blade motor 32 using the one or more power transistors based on one or more inputs to the control system 38 by the operator of the electric lawnmower 10.

The blade motor driver 34 can be configured to initiate, adjust or terminate supply of voltage or current from the battery pack 30 to the blade motor 32 based on inputs received from the control system 38, the battery pack 30 and the blade motor 32. The blade motor driver 34 can also be configured to regulate the charging of the battery cell(s) of the battery pack 30.

The drive assembly 36 can be mounted to the cutter housing 12 at a position that is underneath the cutter housing 12. The drive assembly 36 can include a drive transmission 40 and a propulsion motor driver 42. The propulsion motor driver 42 can be in electrical communication with each of the battery pack 30 and the drive transmission 40. A drive shaft 44 can be connected to each of the drive transmission 40 and at least one of the rear wheels 16 (and/or front wheel(s) 14) in any appropriate manner such that the drive transmission 40 can cause the drive shaft 44 to rotate, which in turn can cause the rear wheels 16 (and/or front wheel(s) 14) to rotate.

The drive transmission 40 can also include a propulsion motor 46 and a gear transmission 48 connecting the propulsion motor 46 to the drive shaft 44. The propulsion motor 46 can be a direct current electric motor or an alternating current electric motor. The propulsion motor 46 can include one or more sensors that provide the propulsion motor driver 42 with information regarding the temperature, rotational speed, power output, etc., of the propulsion motor 46.

The propulsion motor driver 42 can be in electrical communication with each of the battery pack 30, the control system 38 and the propulsion motor 46. The propulsion motor driver 42 can be configured to convert power from the battery pack 30 into output power supplied to the propulsion motor 46. The propulsion motor driver 42 can be configured to monitor the operational conditions of the propulsion motor 46 and the battery pack 30. The propulsion motor driver 42 can be configured to control the voltage or current output by the battery pack 30 based on the operational conditions of the propulsion motor 46 and the battery pack 30 by switching one or more power transistors to adjust the supply of electrical power to the propulsion motor 46.

The propulsion motor driver 42 can also be configured to control the voltage or current output by the battery pack 30, and to supply the voltage or current to the propulsion motor 46 based on one or more inputs by the operator of the electric lawnmower 10 using the one or more power transistors.

The propulsion motor driver 42 can be configured to initiate, adjust or terminate supply of voltage or current from the battery pack 30 to the propulsion motor 46 based on inputs received from the battery pack 30, the propulsion motor 46, and/or one or more user inputs to the control system 38.

The display 19 can be mounted on the handle 18 and in electrical communication with the power controller 60. The display 19 can display a health status of the battery 30. For example, the display can show the health status by displaying a level of battery power remaining utilizing LEDs that can be included in the display 19, a level of heat of the battery, a level of instant or averaged power output of the battery, etc.

Referring to FIG. 1, the lawnmower 10 can include an X-axis, a Y-axis and a Z-axis. The X, Y, and Z-axes are displaced away from the lawnmower 10 for clarity of the drawing. However, the origin O is intended to be located on the driveshaft 44 and equidistant from each of the rear wheels 16.

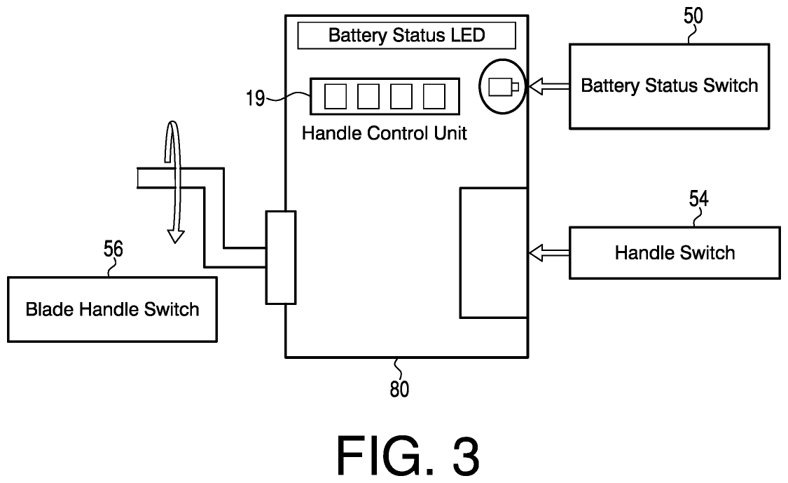

FIG. 3 is a schematic representation of the handle control unit 80 (also referred to as the handle controller) including the battery switch 50, the handle switch 54, the blade switch 56, and the display 19, and possibly the transmission speed switch 58.

The handle controller 80 can be in electrical communication with each of the battery 30, the main controller 70, and the power controller 60. The handle controller 80 can receive electrical power from the battery 30 through the main controller 70. The handle controller 80 can be in electrical communication with each of the battery switch 50, the handle switch 54, the blade switch 56, the display 19, and possibly the transmission speed switch 58. The handle controller 80 can receive input(s) from the handle switch 54 and the blade switch 56 and possibly the transmission speed switch 58 and can send the input(s) directly or indirectly to the main controller 70. The handle controller 80 can receive battery health status from the power controller 60 and can output the battery health status on the display 19. Alternatively, the handle controller 80 can receive battery health status directly from the battery 30 or from the main controller 70. The handle controller 80 can be disposed in the handle 18 on any appropriate structure such as a printed circuit board (PCB), LCD display, LED display, or any other appropriate display or at any other location adjacent the handle of the lawnmower 10.

The battery switch 50 can have three different functions depending on an operator's input and/or the operational state of the lawnmower 10. The battery switch 50 can be configured to issue a wake-up signal in response to a wake-up input, issue a battery status request signal in response to a battery status input, and issue a shut-down signal in response to a shut-down input.

The wake-up input can be actuation of the battery switch 50 when the power switch 52 is in the OFF state.

The battery status input can be actuation of the battery switch 50 sustained less than a predetermined time when the power switch 52 is in the ON state, and the shut-down input can be actuation of the battery switch 50 sustained greater than or equal to a predetermined time when the power switch 52 is in the ON state.

Alternatively, the battery status input can be a single actuation of the battery switch 50 within a predetermine time when the power switch 52 is in the ON state, and the shut-down input can be more than one actuation of the battery switch 50 within a predetermined time when the power switch 52 in in the ON state.

The battery switch 50 can send a first signal or a second signal to the power controller 60. The first signal can refer to actuation of the battery switch 50 within a predetermined time. For example, the first signal can refer to one actuation of the battery switch 50 within a predetermined time. The second signal can refer to more than one actuation of the battery switch 50 within the predetermined time. For example, the second signal can refer to two actuations of the battery switch 50 consecutively within the predetermined time. Alternatively, the second signal can refer to an actuation of the battery switch 50 sustained for longer than a predetermined time. For example, the second signal can refer to actuation of the battery switch 50 that is held for a time greater than the predetermined time, such as three seconds.

The battery switch 50 can be directly connected to the power controller 60. Depending on whether the battery switch 50 sends either the first signal or the second signal to the power controller 60, the power controller 60 can switch the power switch 52 to either the ON or OFF state. The battery switch 50 can be a single-action switch. For example, the battery switch 50 can have a default position to which the battery switch 50 is biased with a spring or other appropriate biasing mechanism and a pressed position that can cause a signal, such as a voltage change or interruption, to be sent when the battery switch 50 is in the pressed position.

When the power switch 52 is in the ON state there can be electrical connection between the battery 30 and any of the plurality of electrically powered devices. When the power switch 52 is in the OFF state, the battery 30 is electrically disconnected from the plurality of electrically powered devices. That is, the power output from the battery 30 is terminated when the power switch 52 is in the OFF state. The power switch 52 can be switched between the ON and OFF states by the power controller 60 in response to the first or second signal from the battery switch 50. The power switch 52 can be a relay, field-effect transistor (FET) or any other appropriate switch mechanism.

The handle switch 54 can have an ON state and an OFF state. The ON state of the handle switch 54 can correspond to a position in which the handle switch 54 has been actuated and the OFF state can correspond to a position in which the handle switch 54 is unactuated. Alternatively, the handle switch can be a single-action switch and an operator can press the handle switch 54 to alternate between the ON position and the OFF position.

The blade switch 56 can have an ON state and an OFF state that each correspond to different rotational positions of the blade switch 56. The ON state of the blade switch 56 can refer to when the blade switch 56 is actuated and the OFF state of the blade switch 56 can refer to when the blade switch is unactuated. For example, the default position of the blade switch 56 with no rotation can correspond to the OFF state and the position in which the blade switch 56 has been rotated toward an operator of the lawnmower 10 can correspond to the ON state. The default state of the blade switch 56 can be the OFF state and the blade switch 56 can be biased to the OFF state with a spring or any other appropriate biasing mechanism so that when an operator lets go of the blade switch 56 it moves to the OFF state.

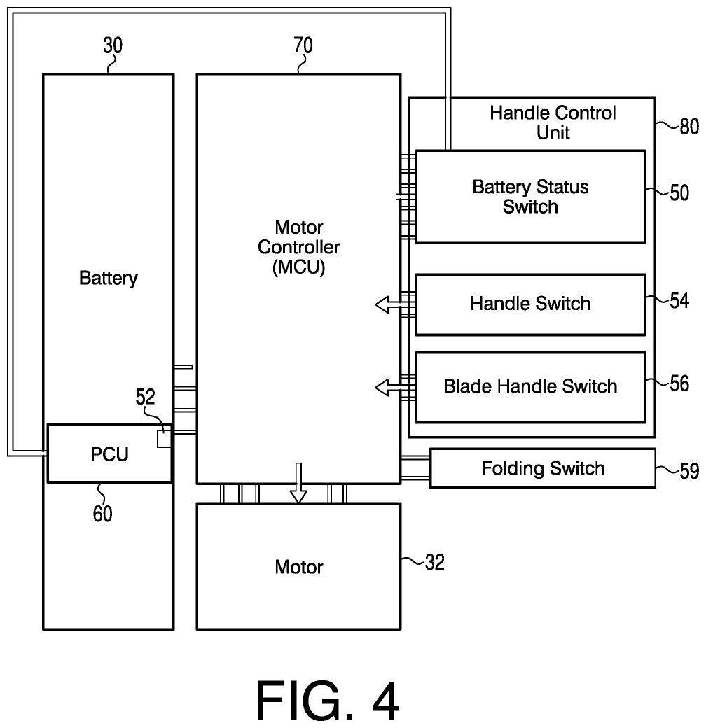

FIG. 4 is a schematic representation of the control system 38 including the battery 30, the power controller 60, the main controller 70, the blade motor 32, the battery switch 50, the handle switch 54, the blade handle switch 56, and a folding switch 59.

The main controller 70 can be configured to electrically connect to the battery 30 when the power switch 52 is in the ON state, and electrically disconnect from the battery when the power switch 52 is in the OFF state. The main controller 70 can be configured to turn on the blade motor 32 when the handle switch 54 is in the ON state and the blade switch 56 is in the ON state.

The power controller 60 can be configured to control the voltage and/or current output by the battery 30 based on operator inputs to the control system 38 and/or the operational conditions of the battery pack 30 by switching the power switch 52 to adjust the supply of electrical power to main controller 70, the handle controller 80, or any other electrical component of the lawnmower 10. The power controller 60 can be configured to switch the power switch to the ON state to electrically connect the battery 30 to at least one of the plurality of electrically powered devices when the power controller receives the wake-up signal. The power controller 60 can be configured to cause the display 19 to display information indicative of a status of the battery 30 when the power controller 60 receives the battery status request signal. The power controller 60 can be configured to switch the power switch 52 to the OFF state to terminate output from the battery 30 to the plurality of electrically powered devices when the power controller receives the shut-down signal.

The folding switch 59 can be configured to disconnect electrical power between the battery 30 and any other electrically powered device in the lawnmower 10. The folding switch 59 can override all or most other switches and electrical connections in the lawnmower 10 so as to prevent transmission of electrical power from the battery 30. The folding switch 59 can be disposed anywhere throughout the wire harness of the lawnmower 10 such that it can electrically disconnect the battery 30 from the wire harness. The folding switch 59 can have an ON state and an OFF state. In the ON state, electrical power can travel through the wire harness and in the OFF state electrical power is prevented from traveling through the wire harness. The folding switch 59 can be in the ON state when the lawnmower is in normal operational conditions. The folding switch 59 can be in the OFF state when the handle 18 of the lawnmower 10 is folded. For example, the handle 18 of the lawnmower 10 can be folded when an operator is storing the lawnmower 10 between uses. In this stored state, the folding switch 59 can be in the OFF state and most or all of the electrical communications to and from the battery 30 can be electrically disconnected.

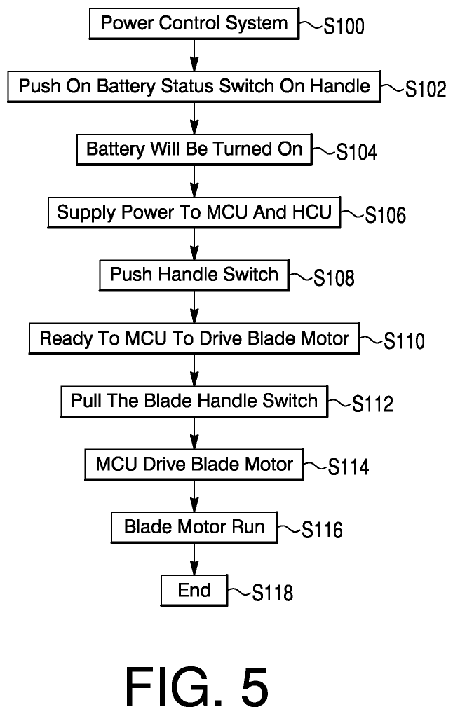

FIG. 5 illustrates a flowchart of an exemplary power control system algorithm that the battery management system 38 can execute to transition from the sleep mode to operational mode and to cause the battery 30 to deliver power to the main controller 70 to drive the rotation of the blade 22 and/or wheel(s) 14, 16. The battery management system 38 can initiate the power control system algorithm at step S100. Subsequently, the battery management system 38 can move to step S102.

At step S102, the operator of the lawnmower can push the battery switch 50 on the handle 18. This can transmit an electrical signal to the power controller 60. The electrical signal can cause the power controller 60 to switch the power switch 52 to the ON state to turn on the battery 30 and electrically connect the battery 30 to the plurality of electrically powered devices as indicated in step S104.

Once the power switch 52 is in the ON state, the battery 30 can supply electrical power to the main controller 70 and the handle controller 80 as indicated in step S106.

When the operator pushes the handle switch 54 as in step S108, the handle switch 54 can transmit an electrical signal to the main controller 70. Upon receiving the electrical signal from the handle switch 54, the main controller 70 can provide a ready signal to prepare to drive the blade motor 32 as indicated in step S110.

When the operator pulls the blade handle switch 56 in step S110, the blade handle switch 56 can transmit an electrical signal to the main controller 70. Upon, receiving the electrical signal from the blade handle switch 56, the main controller 70 can cause the blade motor 32 to turn on as indicated in step S112 and rotate the blade 22 as indicated in step S114.

The blade motor can run at step S116.

When the blade motor 32 is on, the operator can either press and hold the battery switch 50 or release the blade handle switch 56 such that the operator no longer grasps the blade handle switch 56 and the blade handle switch 56 returns to the OFF state. Either of these actions by the operator can signal the main controller 70 to cause the blade motor 32 to stop rotation of the blade 22 as indicated at step S118.

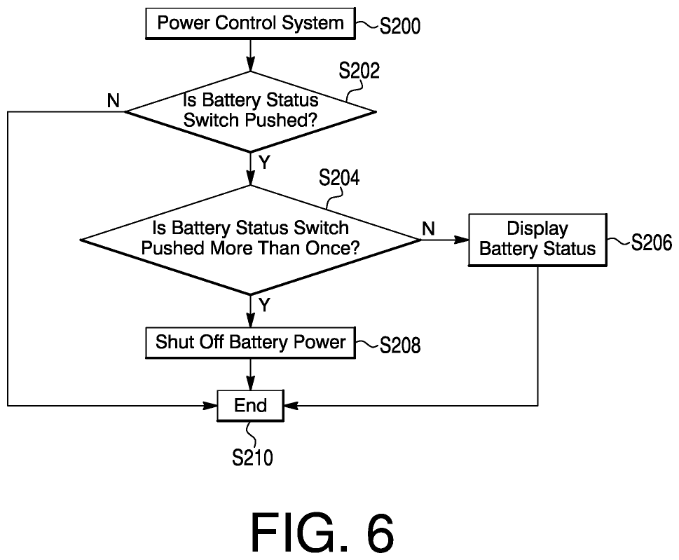

FIG. 6 illustrates a flowchart of an exemplary power control system algorithm that the battery management system 38 can execute to display the battery status of the battery 30 or to terminate power to the main controller 70 to stop rotation of the blade. The battery management system 38 can initiate the power control system algorithm at step S200 when the power switch 52 is in the ON state. Subsequently, the battery management system 38 can move to step S202.

The power controller 60 can check whether it has received an electrical signal from the battery switch 50 indicating that the battery switch 50 has been pushed. If the battery switch 50 has not been pushed, the algorithm can proceed to end at step S210. If the battery switch 50 has been pushed, the algorithm can proceed to step S204.

At step 204 the power controller 60 can check whether the electrical signal sent from the battery switch 50 is a power off request. If the electrical signal sent from the battery switch 50 is not a power off request, the power controller can send a signal to the display 19 to display a battery health status as indicated in step S206. Once the battery health status has been displayed, the algorithm can proceed to end at step S210.

If the electrical signal sent from the battery switch 50 is a power off request, the algorithm can proceed to step S208.

At step S208, the power controller 60 can command the power switch 52 to the OFF state and terminate electrical connection between the battery 30 and the plurality of electrically powered devices. Once the electrical connection between the battery 30 and the electric devices is terminated, the algorithm can proceed to step S210 and end the algorithm.

Electrical communication lines (not numbered) can connect the battery 30, power controller 60, power switch 52, motor controller 70, motor 32, battery status switch 50, handle switch 54, blade handle switch 56, and folding switch 59 to each other and any of the plurality of electrically powered components in any appropriate manner. Electrical communication can be either one-way communication or two-way communication and can be networked or not networked. Switches and/or sensors can be configured with hardware, with or without software, to perform the assigned task(s). Switches and/or sensors can be configured as smart switches and/or sensors such that the switches and/or sensors can process the raw data collected by the switches and/or sensors prior to transmission to the any of the controllers or the switches and sensors can be configured as a simple switches and/or sensors that passes the raw data directly to the controllers without any manipulation of the raw data. The switches and/or sensors can be configured to send data to any of the controllers, with or without a prompt from the controller(s).

Each electrical connection can include a wire harness that can include a signal line and a power line. That is, the connections between the battery 30 and main controller 70, the power controller 60 and the main controller 70, and the main controller 70 and each of the blade motor 32, handle switch 54, blade handle switch 56, battery switch 50, and folding switch 59 can include at least a signal line and power line. The signal line can transmit electrical signals such as, but not limited to, the first signal, the second signal, the ON state, the OFF state, etc. The power line can transmit electrical power such that electrical current can flow between the electrical connections. The battery status switch 50 can include a designated signal line to the battery 30 independent of the power switch 52 so that the battery status switch 50 can send the wake-up signal upon actuation even when the power switch is in the OFF state.

While certain embodiments of the invention are described above, it should be understood that the invention can be embodied and configured in many different ways without departing from the spirit and scope of the invention.

The battery switch 50, the handle switch 54, and the blade handle switch 56 can be any appropriate switch including but not limited to, a button, a toggle, a capacitance sensor, keyed switch, dimpled switch, etc. Additionally, any of the switches disclosed can be configured as a relay, field-effect transistor (FET) or any other appropriate switch mechanism. In addition, in some embodiments, actuation of a switch is described as being accomplished by pulling or pushing the switch. It should be understood that actuation can be accomplished by the reverse of what is described (i.e., a switch can be pushed for actuation despite being described as being pulled for actuation above).

Embodiments are disclosed above in which the battery switch 50, the handle switch 54, and the blade handle switch 56 each have an ON state and an OFF state. The ON state can refer to as when the respective switch is actuated and the OFF state can refer to when the respective switch is unactuated because the switch can have a spring that biases the switch to the OFF state by default.

Embodiments are disclosed above in which the propulsion motor 46 can be an electric motor. However, embodiments are also intended to include or otherwise cover power equipment apparatus that can include an internal combustion engine, or a hybrid of an internal combustion engine and an electric motor.

Embodiments are disclosed above in which the power switch 52 electrically disconnects from, or terminates output to, the plurality of electrically powered devices. However, embodiments are intended to include or otherwise cover the power switch 52 terminating output from one of the plurality of electrically powered devices or any combination of the plurality of electronic devices. In another alternate embodiment, the power switch 52 can include multiple switches that can selectively electrically connect and/or terminate any combination of the plurality of the electrically powered devices together or separately.

The handle 18 is shown as a typical U-shaped handle for a walk behind mower, but can be configured as a steering wheel or dual levers for tractor or ZTR mowers, respectively. The handle 18 can also be incorporated into a dashboard of a mower device that might be autonomously controlled or steered.

We also note the predetermined time for actuation of a switch to cause a first signal, and the “another predetermined time” for actuation of the switch to cause a second signal can be the same or different time period.

Embodiments are disclosed above in which the power controller is configured to cause the display 19 to display a health status of the battery 30. The health status of the battery can be stored in a memory or RAM of the lawnmower. The health status can be continuously stored in the memory or stored at predetermined intervals. The power controller 60 can retrieve the health status from the memory. Alternatively, the power controller 60 can be configured to open a gateway connected to the battery 30 to allow a voltage reading from the battery 30 to be read by the power controller 60 or the main controller 70 and then output to the display 19. Reading of the voltage from the battery 30 to determine the health status can be a periodic sub-routine of the operation of the lawnmower 10 or can be performed when the battery health status is requested by an operator.

Embodiments are disclosed above in which the main controller 70 receives and sends battery health status, monitors voltage of the battery 30, and receives requests to distribute electrical power based on user inputs. However, embodiments are intended to include or otherwise cover the power controller 60 performing these functions as a standalone controller or together with the main controller 70 on a same circuit board.

What is claimed is:

1. A battery management system for a lawnmower having a handle, a display mounted on the handle, a battery, and an electrically powered device, the battery management system comprising:
a first switch configured to issue a wake-up signal in response to a wake-up input, issue a battery status request signal in response to a battery status input, and issue a shut-down signal in response to a shut-down input;
a second switch between the battery and the electrically powered device; and
a first controller configured to,
switch the second switch to an ON state to electrically connect the battery to the electrically powered device when the first controller receives the wake-up signal,
cause the display to display information indicative of a status of the battery when the first controller receives the battery status request signal, and
switch the second switch to an OFF state to terminate output from the battery to the electrically powered device when the first controller receives the shut-down signal.

2. The battery management system of claim 1, wherein
the wake-up input is actuation of the first switch when the second switch is in the OFF state.

3. The battery management system of claim 2, wherein
the battery status input is actuation of the first switch sustained less than a predetermined time when the second switch is in the ON state, and
the shut-down input is actuation of the first switch sustained greater than or equal to the predetermined time when the second switch is in the ON state.

4. The battery management system of claim 2, wherein
the battery status input is one actuation of the first switch within a predetermined time when the second switch is in the ON state, and
the shut-down input is more than one actuation of the first switch within another predetermined time when the second switch is in the ON state.

5. The battery management system of claim 1, further comprising:
a second controller connected to the electrically powered device;
a third switch connected to the second controller; and
a fourth switch connected to the second controller,
the second controller configured to drive the electrically powered device when the third switch is in an ON state and the fourth switch is in an ON state.

6. The battery management system of claim 5, further comprising:
the electrically powered device, and the electrically powered device is a blade motor.

7. The battery management system of claim 5, wherein
the battery status input is actuation of the first switch when the second switch is in the ON state and the third switch is in the ON state.

8. A battery management system for a lawnmower having a handle, a display mounted on the handle, a battery, and an electrically powered device, the battery management system comprising:
a switch mounted on the handle; and
a power controller configured to,
switch a power switch to an ON state to electrically connect the battery to the electrically powered device when the power switch is in an OFF state and the power controller receives a first signal from the switch,
cause the display to display information indicative of a status of the battery when the power controller receives the first signal and the power switch is in the ON state,
switch the power switch to the OFF state to terminate output from the battery to the electrically powered device when the power switch is in the ON state and the power controller receives a second signal from the switch that is different from the first signal.

9. The battery management system of claim 8, further comprising:
a main controller configured to,
electrically connect to the battery when the power switch is in the ON state,
electrically disconnect from the battery when the power switch is in the OFF state.

10. The battery management system of claim 9, further comprising:
a handle controller including a handle switch and a blade switch, the handle controller configured to
electrically connect to the main controller when the handle switch is in an ON state.

11. The battery management system of claim 10, wherein
the electrically powered device is a blade motor, and
the main controller is configured to turn on the blade motor when the handle switch is in the ON state and the blade switch is in an ON state.

12. The battery management system of claim 8, wherein
the first signal is an actuation of the switch within a predetermined time, and
the second signal is more than one actuation of the switch within the predetermined time when the power switch is in the ON state

13. A lawnmower having the battery management system of claim 8, comprising:
a deck;
a blade rotatably supported in the deck;
a plurality of wheels connected to the deck;
the handle connected to the deck and extending away from the deck,
the display mounted on the handle, and
the battery mounted on the deck.

14. The lawnmower of claim 13, wherein
the battery and the handle are spaced away from each other.

15. The lawnmower of claim 14, wherein
the power controller is on the battery.

16. The lawnmower of claim 13, further comprising:
a blade motor configured to selectively rotate the blade;
a main controller;
a handle controller electrically connected to the main controller;
a handle switch connected to the handle controller and mounted on the handle;
a blade switch connected to the handle controller and mounted on the handle;
the main controller is configured to,
electrically connect to the battery when the power switch is in the ON state,
electrically disconnect from the battery when the power switch is in the OFF state,
the main controller is configured to turn on the blade motor when the handle switch is in the ON state and the blade switch is in an ON state.

17. The battery management system of claim 8, wherein
the switch is a single-action switch.

18. A battery management system for a lawnmower having a deck, a handle extending from the deck, a display mounted on the handle, a battery, a blade rotatably supported in the deck, and a blade motor, the battery management system comprising:
a battery switch mounted on the handle;
a motor controller connected to the blade motor;
a power switch between the battery and the motor controller;
a power controller configured to,
switch the power switch to an ON state to electrically connect the battery to the motor controller when the power switch is in an OFF state and the power controller receives a first signal from the battery switch,
cause the display to display information indicative of a status of the battery when the power controller receives the first signal and the power switch is in the ON state,
switch the power switch to the OFF state to terminate output from the battery to the motor controller when the power switch is in the ON state and the power controller receives a second signal from the battery switch that is different from the first signal.

19. The battery management system of claim 18, further comprising:
a handle controller having a handle switch and a blade switch;
the motor controller configured to
drive the blade motor when the handle switch and the blade switch are both in an ON state when the power switch is in an ON state; and
the power controller configured to
switch the power switch to the ON state to electrically connect the battery to the motor controller and the handle controller when the power switch is in an OFF state and the power controller receives a first signal from the battery switch, and
switch the power switch to the OFF state to terminate output from the battery to the motor controller and the handle controller when the power switch is in the ON state and the power controller receives a second signal from the battery switch that is different from the first signal.

20. The battery management system of claim 18, wherein
the first signal is actuation of the battery switch sustained less than a predetermined time, and
the second signal is actuation of the battery switch sustained greater than or equal to another predetermined time when the power switch is in the ON state.
